(19) United States
(12) Patent Application Publication
(10) Pub. No.: US 2024/0028944 A1
(43) Pub. Date: Jan. 25, 2024

(54) ONLINE DRIFT DETECTION FOR FULLY UNSUPERVISED EVENT DETECTION IN EDGE ENVIRONMENTS

(71) Applicant: Dell Products L.P., Round Rock, TX (US)

(72) Inventors: Vinicius Michel Gottin, San Jose, CA (US); Herberth Birck Fröhlich, Florianopolis (BR); Julia Drummond Noce, Rio de Janeiro (BR); Ítalo Gomes Santana, Rio de Janeiro (BR)

(21) Appl. No.: 17/813,714

(22) Filed: Jul. 20, 2022

(51) Int. Cl. G06N 20/00

(52) U.S. Cl. CPC G06N 20/00

(57) ABSTRACT

One example method includes receiving a stream of unlabeled data samples from a model, obtaining a first reconstruction error for the unlabeled data samples, obtaining a second reconstruction error for a set of normative data, defining a margin based on the first reconstruction error and the second reconstruction error, computing an initial proportion of samples from the set of normative data whose reconstruction errors fall within a range of reconstruction errors defined by the margin, computing a new proportion of unlabeled data samples that fall within the range of reconstruction errors defined by the margin, and signaling drift in the performance of the model when said new proportion differs from said initial proportion by more than a predefined tolerance threshold.

### RELATED APPLICATION

This application is related to U.S. patent application Ser. No. 17/663,423, entitled UNSUPERVISED LEARNING FOR REAL-TIME DETECTION OF DANGEROUS CORNERING EVENTS IN FORKLIFT TRAJECTORIES FOR EDGE-LOGISTICS ENVIRONMENTS, filed 14 May 2022, which is incorporated herein in its entirety by this reference.

### FIELD OF THE INVENTION

Embodiments of the present invention generally relate to the implementation and use of machine learning models. More particularly, at least some embodiments of the invention relate to systems, hardware, software, computer-readable media, and methods, for the detection of drift in the operation of machine learning models.

### BACKGROUND

Machine learning model drift detection in fully unsupervised domains has proven to be a difficult problem. Taking, for example, the operation of mobile edge nodes such forklifts operating in a warehouse environment, labeled data acquisition in the context of dangerous cornering detection would require acquiring and annotating the mobile device trajectories and all their correlated sensor information, such as positioning and acceleration for example, in order to be able to determine that a dangerous cornering event is occurring, or is about to occur.

Such an approach is not feasible, however. First, the volume of data may be too large for practical labeling by human experts. Further, the raw sensor data is not easily interpretable, and the detection of cornering events in that raw sensor data is a challenge in itself. As well, dangerous cornering events cannot be easily generated on-demand in the environment. It is unfeasible and impractical, for example, to ask an operator to carelessly drive a mobile edge device such as a forklift so as to enable the generation and collection of data concerning anomalous cornering events, or to have an autonomous vehicle operate repeatedly in a real environment, and in every configuration of unsafe behavior possible, to generate a sufficiently representative training set for a machine leaning model.

Still another problem is that the absence of labels, that is, event indications in the training data, affects the training of the event detection itself, as building predictive (supervised) machine learning models requires the collection of a large amount of labeled data. In contrast, an unsupervised model may be used for real-time event detection.

Finally, and with particular reference to the task of drift detection, it may be the case that labels do not become available, if at all, even after the events of interest have taken place. This means that the performance of an event detection model is not trivially verified, but also means that the performance of the model cannot be used to assess drift in a straightforward fashion.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example training stage for some embodiments.

FIG. 2 discloses aspects of components and processes for obtaining a reconstruction error.

FIG. 3 discloses an example near-edge environment for deployment of some example embodiments.

FIG. 4 discloses an example set of anomalous data.

FIG. 5 discloses example reconstruction error distributions for normative and anomalous data.

FIG. 6 discloses an example of a margin as employed by some embodiments.

FIG. 7 discloses a proportion ‘r’ of data samples whose reconstruction error falls within a particular margin.

FIG. 8 discloses an example method according to some embodiments.

FIG. 9 discloses an example computing entity operable to perform any of the disclosed methods, processes, and operations.

### DETAILED DESCRIPTION OF SOME EXAMPLE EMBODIMENTS

Embodiments of the present invention generally relate to the implementation and use of machine learning models. More particularly, at least some embodiments of the invention relate to systems, hardware, software, computer-readable media, and methods, for the detection of drift in the operation of machine learning models. Some particular embodiments may be employed in connection with unsupervised event-detection machine learning (ML) models, which may be deployed in mobile edge devices that are operating in an edge computing environment, and that are operable to communicate with one or more near-edge nodes, and a central node.

In general, example embodiments of the invention may employ an autoencoder-based approach for event detection in unsupervised domains. For the purposes of illustration only, reference is made herein to an example use-case of a large-scale logistics warehouse in which mobile entities, such as forklifts for example, are equipped with sensors and operate as far-edge nodes in relation to a near-edge local infrastructure. Example embodiments may operate to perform model drift detection in these scenarios. Example embodiments may operate to determine, possibly in real time, whether a proportion of reconstruction errors is changed from an expected baseline number of reconstruction errors. Such determinations may be based on a known proportion of events of interest in the domain of interest, as well as the performance of the autoencoder in reconstructing normative samples.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

For example, an embodiment may operate to perform drift detection with respect to the performance of an ML model that is operating to implement unsupervised event detection in a domain. Thus, such embodiments may enable improvements to the performance of such an ML model, and/or the performance of an associated mobile edge device, by determining whether the ML model is drifting or not. A drifting ML model may then be refined, or replaced. Various other advantageous aspects of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Example embodiments may generally be concerned with the task of drift detection in the performance of ML models, or simply ‘models.’ Some particular embodiments may be concerned with detecting drift in unsupervised event-detection models applied over sensor streams in edge environments.

As a representative use-case, not limiting in any way the scope of the invention, example embodiments may consider the task of detecting dangerous cornering events in trajectories of mobile devices, such as forklifts for example, at the far edge, that is, in an edge computing environment.

One particular challenge in real-time event detection at the edge is that labels are typically not available regarding data that is generated and/or collected by an edge device. However, conventional supervised learning approaches require data labels, or simply ‘labels,’ indicating the events of interest.

Because, as noted, labels may not be available in some circumstances however, an unsupervised approach to event detection in an edge environment may be required. One possible implementation of such an unsupervised approach is disclosed in the ‘Related Application’ identified herein. In that example approach, an autoencoder may be trained using a training set X which includes only normative behavior, that is, for example, behavior that comprises normal, safe, mobile edge device cornering events. When applied over a test set Y, the autoencoder may yield reconstruction errors for each sample. Samples with a high reconstruction error, above a predetermined threshold for example, may be assigned as relevant events, that is, potentially dangerous cornering events. Some example embodiments of the invention may employ an approach such as is disclosed in the ‘Related Application,’ and may further perform drift detection over, that is, with respect to, the event-detection.

### B. Context for Some Example Embodiments

### B.1 Unsupervised Event Detection Via Autoencoder

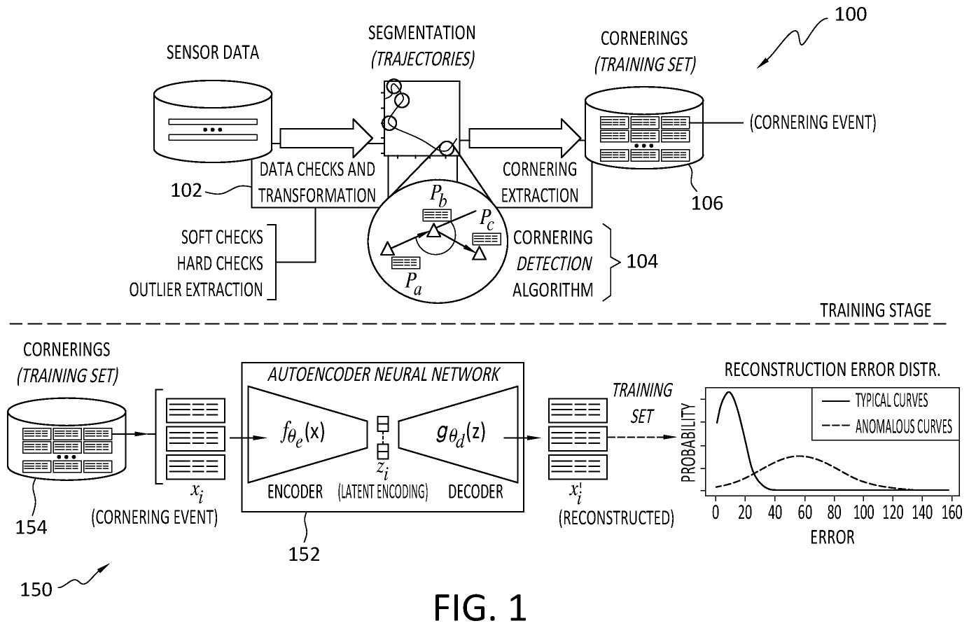

The ‘Related Application’ discloses a representative embodiment of a cornering detection approach via anomaly detection. The approach performs a training stage, leveraging the data collected at a near-edge node. This is represented in the configuration 100 of FIG. 1 which discloses, in particular, a representation 102 of the data checks and transformation, and a cornering detection algorithm 104, in a training stage. FIG. 1 also discloses a representation 150 of the training of an autoencoder neural network 152 that minimizes the reconstruction error for the cornering events in the training set 154.

In the example of FIG. 1, the training stage may define various components. For example, the training stage may define data checks and a transformation pipeline. In general, such data checks may deal with issues such as data availability, and data noise, and the data checks may perform domain-appropriate data segmentation. Further, data checks may serve to filter out known outliers and any known edge-cases.

The training stage may further comprise, in the illustrative example of mobile edge devices operating in warehouse, a cornering detection algorithm 104. The cornering detection algorithm may operate to capture triplets of positioning data, along with associated inertial measurements, and may operate to compose a training set of cornering events.

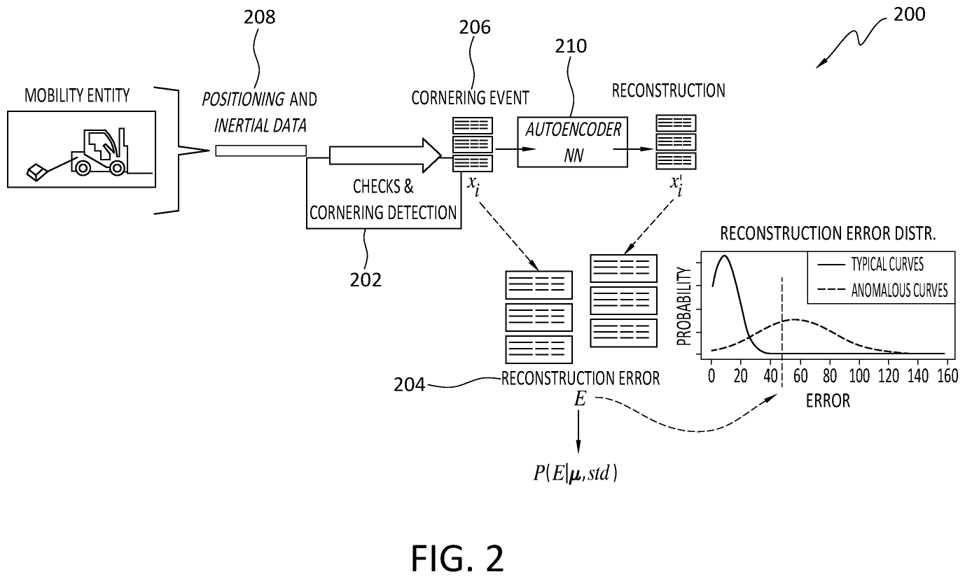

As well, the training stage may comprise an autoencoder model that may be trained to reconstruct typical cornering events. In some instances, a reconstruction error distribution may additionally be obtained obtain for the typical cornering events in the training set 106. These cornering events may then be deployed to each mobile entity for online decision making, leveraging the sensor data stream at the entity itself, as disclosed in FIG. 2.

Particularly, the configuration 200 of FIG. 2 discloses at 202 the data checks and transformations, if required, the cornering detection, and the obtaining of a reconstruction error 204 for a detected cornering event 206 at the mobile entity in near real-time during operation. The data 208 collected by the positioning and inertial sensors is checked and transformed and composed into cornering events 206 which are then input to the autoencoder model 210. The transformations may not be necessary, for example, if they are specific to the training stage.

The approach referred to in FIG. 1 and FIG. 2 may leverage the fact that dangerous cornering events are not present, or are sufficiently rare, as ensured by the data checks, in the training set 106. Thus, the autoencoder model may not be able to reconstruct those events as well, resulting in larger reconstruction errors for dangerous cornering events. This may be implemented as follows: if a cornering event is detected, a reconstruction error E may be obtained—this error E may be compared to a threshold based on the parameters of the reconstruction error distribution for the typical cornering events in the training set. Alternatively, the approach can output a normalized reconstruction score. The normalized reconstruction score may then be used in further processing at the mobile entity. For example, a standalone event detection engine can determine whether that event is a dangerous cornering event. Alternatively, an operation control module may use that score to automate the movement of the mobile entity.

### B.2 Unsupervised Drift Detection

Drift detection is an area of significant research in machine learning, and there are many approaches applicable for the detection of nonstationary distributions comprising data and/or concept drift. At least some example embodiments are concerned particularly with unsupervised drift detection in streaming data, such as may be generated by edge devices such as sensors for example. At least some embodiments of the invention may consider the number of samples in an uncertainty region of an event detection model. In contrast with approaches which determine similar uncertainty regions for classifier models, example embodiments may implement a fully unsupervised approach. That is, an event detection model according to some embodiments of the invention may, itself, be unsupervised, and no labeled data is made available to that event detection model to correct or guide the drift detection approach over time.

### C. Aspects of Some Example Embodiments

Example embodiments of the invention may define, implement, and operate, a drift detection approach for an unsupervised event-detection model that is operating in an edge environment. Embodiments may comprise an offline training stage for the drift detection approach, which may coincide with the training stage for the event detection model itself, and an online drift detection stage, which may coincide with the online event detection inferencing stage.

This approach taken by some example embodiments may present various advantages. For example, this approach may be applicable to use cases in a fully-unsupervised domain. As another example, this approach may be applicable to the use case of event detection. Further, this approach may implement online determination of drift, albeit for a window of past samples. Further, this approach may operate unsupervised in a drift detection stage. Finally, this approach may not require the existence of a temporal relation between samples, but only the reconstruction errors, in the training stage.

The example embodiments disclosed herein may be useful in a variety of domains, at least insofar as such embodiments may operate to serve as a warning system of possible drift in the operation of an unsupervised event detection model.

Furthermore, example embodiments may be used in conjunction with others approaches, such that, for example, upon identification of a window of drift by an example embodiment, a more robust, and possibly more expensive or delayed approach, may be selectively applied to a particular model and/or set of circumstances.

### C.1 Offline Stage

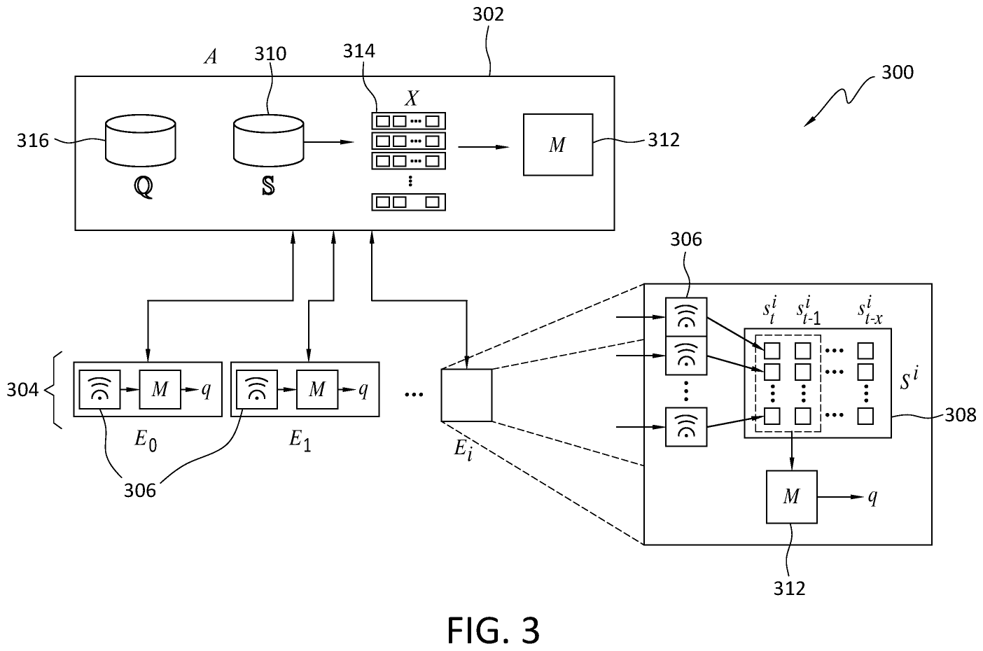

As noted above, example embodiments may comprise an offline stage, which may be implemented in an edge environment, such as the example edge environment 300 disclosed in FIG. 3.

### C.1.1 Example Environment

In particular, FIG. 3 discloses an example implementation of a near-edge central node ‘A’ 302, which may comprise various robust computational resources, such as processors and memory, deployed in the edge environment 300. Each edge node Eᵢ 304 may comprise, or be implemented in, a mobile entity that may be equipped with one or more sensors 306. An appropriate communication scheme between the edge nodes 304 and the central node 302 may be implemented, as may be typical in some edge domains.

The edge device Eᵢ, equipped with sensors 306, may operate to collect and process data as a sensor stream Sᵢ 308. The data from these sensor streams Sᵢ 308 may be collected over time at the central node ‘A’ 302 into a centralized repository [symbol] 310. The management and orchestration of the repository [symbol] 310, such as with the discarding of outliers, compression, or discarding of too-old samples, may be implemented in some embodiments.

As noted earlier, embodiments may obtain an event detection model ‘M’ 312. In the case of FIG. 3, the model ‘M’ 312 may be trained at the central node ‘A’ 302 using training data ‘X’ 314 extracted from Sᵢ 308, and the trained model ‘M’ 312 may then be deployed to the edge nodes Eᵢ 304. The composition of sample x ∈ ‘X’ may depend on the model ‘M’ 312. Furthermore, the raw sensor data in the repository [symbol] 310 may be subject to data checks and a transformation pipeline, such that only normative data may be relevant for X. Alternative training schemes for the model ‘M’ 312, such as federated learning for example, may be employed in some embodiments, depending on the domain, so long as adequate computational resources are available at the edge nodes that would be participating in the federated learning process.

Example implementations of a model ‘M’ 312 deployed at the edge nodes 304 may perform event detection and yield an event indication q for each appropriate input, which input may comprise a collection of sensor data and/or contextual information. In example embodiments, q may correspond to a reconstruction error yielded by an autoencoder, that is, a drift detection model, that is included as part of the model ‘M’ 312. In similar fashion to the sensor data, the event indications may be communicated and stored at the central node 302 in a repository [symbol] 316. Note that q may indicate how likely it is that particular data correspond to a particular, possibly dangerous, event.

### C.1.2 Anomalous Data

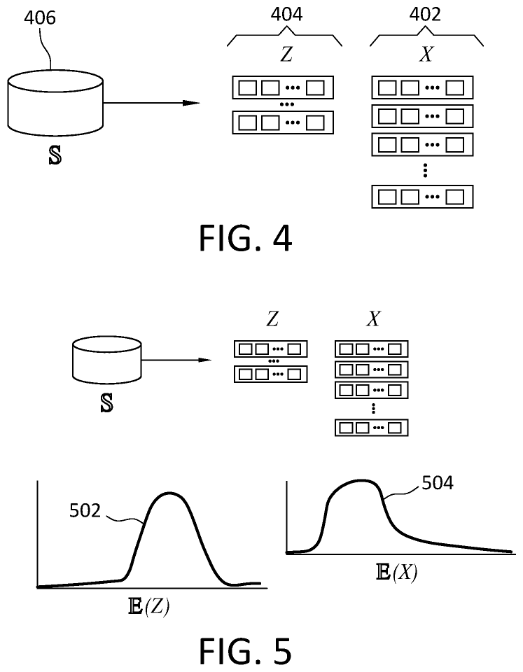

With reference now to FIG. 4, example embodiments of the invention may employ anomalous data Z, which may have various characteristics.
(A) For example, if sufficient and representative historical data is available, such as from [symbol] and [symbol] , then Z may comprise sensor data Sⱼⁱ and associated event indication qⱼ from [symbol] and [symbol] , respectively, when qᵢ is an indication of an anomalous event. In this case, Z may comprise data that was filtered out for the composition of X, as noted in the discussion above concerning data checks and transformations in the training of an autoencoder model.
(B) Data collected from another similar domain may be used as anomalous data for the purposes of some example embodiments. In the illustrative use case of warehouse logistics, Z may comprise the data collected from the operation of mobile entities in a different warehouse.
(C) If such data is note used as Z, however, an appropriate method for generating Z synthetically, that is, for producing synthetic anomalous data Z, may be employed. Such a method for generating Z synthetically may rely, for example, on the alteration of known samples (Sⱼⁱ, qᵢ) when qᵢ is not an indication of anomalous events by a known, predefined, function.

Regardless of the method for obtaining Z, embodiments may assume a proportion P=|z|/|x U z| of anomalous events in the domain of interest, such as mobile edge devices operating in a warehouse for example. In the case (A) above, and with reference to FIG. 4, |X| 402 is the number of events collected in [symbol] and [symbol] and, p may thus be straightforwardly computed. In case (B), the samples in Z may be filtered to respect the proportion p. In the latter case (C), p may have to be determined by a domain specialist or some other source. In practice, only an appropriate of samples may be generated in Z so that the proportion is true to the domain. This is represented in FIG. 4, which discloses a set 404 of anomalous data Z obtained from [symbol] 406 that may comprise, or consist of, synthetic data.

Notice that all these cases (A), (B), and (C), may provide data that may not be normative of the behavior in the domain, and hence may not be able to be used for training an autoencoder for event detection, nor do these cases provide labeled data for the purposes of training. Rather, the data Z 404 may simply comprise samples of synthetic data that may reasonably resemble actual samples, and may be likely to be poorly reconstructed by an autoencoder, as discussed below in connection with FIG. 5.

Particularly, in case (A), Z may comprise mostly outliers from sensor readings and drop-off periods, for example. In case (B), the normative behavior of another instance of the problem is considered. In case (C), the data Z may be purely synthetic, and the model used to generate it may determine the resulting samples. Thus, it is noted that while embodiments may use “known” anomalous data, the use of that anomalous data may still satisfy the requirements for operating the ML model in a fully unsupervised domain.

### C.1.3 Margin

With reference now to FIG. 5, let [symbol] be a reconstruction error function, which may be implemented by an autoencoder model, or drift detection model, included in the model ‘M’ 312, such that [symbol] (d) is the distribution of the reconstruction error for input data d. Note that reference is made to [symbol] as equivalent to [symbol] (x) for a single sample x, though it may be the case, in contexts such as this one, that the reconstruction error refers to a single sample. Next, the reconstruction error [symbol] (Z) may be obtained. This is represented in FIG. 5, which discloses respective distributions 502 and 504 of the reconstruction errors for the data sets Z (anomalous data) and X (training data, for the autoencoder model).

Given the reconstruction error distributions, embodiments may define a margin of confidence over the results of the event detection model. In T. S. Sethi and M. Kantardzic, “On the reliable detection of concept drift from streaming unlabeled data,” Expert Systems with Applications (2017), an approach is proposed for detecting drift from data streams when labels are not readily available, considering uncertainty regions from supervised classifier models. Some embodiments of the invention may adapt, and extend, that approach to be applied over the reconstruction error distributions (see FIG. 5) of the autoencoder model used for event detection in a fully unsupervised fashion.

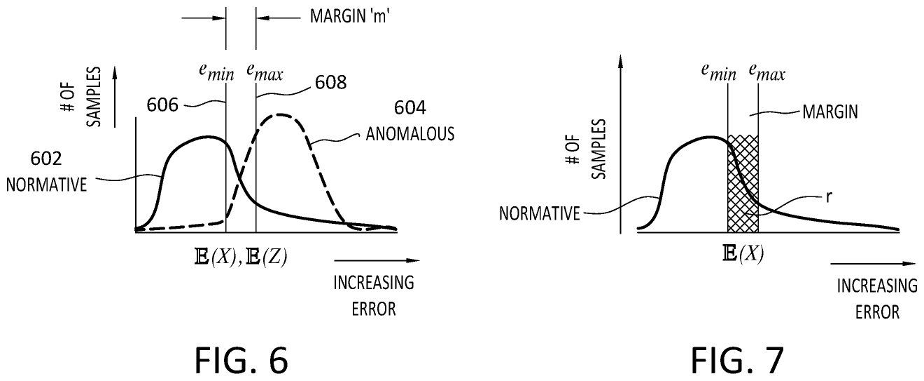

In more detail, and with reference now to FIG. 6, embodiments of the invention may define a margin ‘m’ as the intersection between [symbol] (Zₐ) 602 and [symbol] (X) 604. The margin m determines minimum eₘᵢₙ 606 and maximum eₘₐₓ 608 reconstruction errors that determine uncertainty in the event detection by the model ‘M’ 312. The determination of the margin m may maximize the area of the intersection between the two distributions within the margin m. Typically, data samples with a reconstruction error larger than eₘₐₓ may belong mostly to Z, which may be due to the anomalous nature of Z, while data samples with a reconstruction error smaller than eₘᵢₙ may belong mostly to X, which may be due to the normative nature of X. A representative case is shown in FIG. 6. Particularly, FIG. 6 discloses a representation of the margin over the reconstruction error distributions of Z and X.

Embodiments of the invention may then count the number of samples in the training dataset whose reconstruction errors E fall within the margin. Recall the discussion regarding cases (A), (B) and (C) above. The anomalies in Z may not be representative of different modes of operation in the domain. In case (C), for example, [symbol] (Z) is directly related to the specification of the function for generating synthetic samples. Hence, while these samples may be useful for determining the margin, some example embodiments may consider the reference dataset X only, that is, only the original normative data samples. Embodiments may then denote the proportion of samples with reconstruction error within the margin in the reference set as r. Formally,

$$r = \frac{\vert x : {e}_{min} \leq E \leq {e}_{max} \vert}{\vert X \vert}$$

This is represented in FIG. 7, which discloses that the proportion r of the samples in X with a reconstruction error within the margin may be computed (gray area). Finally, a drift detection module D may be deployed to the edge nodes. That module, which may be included as an element of an unsupervised event detection model such as the model ‘M’ 312 for example, may leverage the margin, eₘᵢₙ, eₘₐₓ, and the proportion r, to perform the drift detection at the edge nodes where the model M is deployed.

### C.2 Online Stage

In some example embodiments, the online stage for drift detection may coincide with the online event detection inferencing stage. As an extension to the operations performed for event detection, embodiments of the invention may operate to continuously keep track of r_{curr} as the current proportion of samples being observed, or extracted from a sensor stream, whose reconstruction errors E falls within the margin.

When the value of r_{curr} is much larger, or much smaller, than the reference margin r, drift may be signaled. The reasoning is that if a larger than expected, or smaller than expected, number of samples are ambiguous, the distribution of the reconstruction errors of the observed samples differs from that which was observed during the training period. This may mean that the underlying distribution of the data itself is changed, or that the autoencoder model no longer works as expected for the current data stream. Thus, if the margin m increases, the model may be drifting. As such, example embodiments may specify a maximum acceptable margin m. The acceptable size of a margin m may be a function of various considerations such as, but not limited to, the application domain where the model M is deployed.

A maximum change δ may be assumed to be provided to the method as an argument. A potential drift may be signaled, for example, when |r_{curr}−r|>δ. In alternative embodiments, different values of maximum positive, and negative, changes in δ can be determined.

Embodiments may additionally determine a series of window w₀, w₁, . . . and keep a corresponding series of values r₀, r₁ . . . , such that rᵢ denotes the proportion of anomalous events detected in the samples extracted from window wᵢ. In this case, embodiments of the invention may indicate which windows of recent samples yield a different proportion of samples within the margin.

For example, the drift indication may be triggered only by a sequence of windows showing a proportion smaller or greater r by at least δ. Alternative approaches in which overlapping windows, and other drift parameters such as drift start, drift end, and drift duration, may be used for determining a likely drift duration.

Finally, as part of the online stage, example embodiments of the invention may consider the updating of the drift detection model D. This may take place in two scenarios:
(1) if the event detection model M is retrained, the margin m and proportion r may have to be recomputed from scratch; and
(2) if some supervision is provided, either by manual labeling of observed samples or an auto-labeling approach, the margins may be periodically recomputed—the process may be similar to the one described in the offline stage but may also consider new known-anomalies as part of Z—furthermore, older data, in both X and Z, may be discarded to determine a new margin m based on current performance of M.

### D. Further Discussion

As will be apparent from this disclosure, example embodiments of the invention may possess various useful features and advantages. For example, embodiments may provide for drift detection in the performance of unsupervised event detection models. An embodiment may be applicable to the use case of unsupervised event detection at edge domains. An embodiment may enable online determination of drift, albeit for a window of past samples. An embodiment may operate in an unsupervised manner both in training, and in the drift detection stage. Finally, embodiments may not require temporal relations between samples, but only the reconstruction errors, in the training stage.

### E. Example Methods

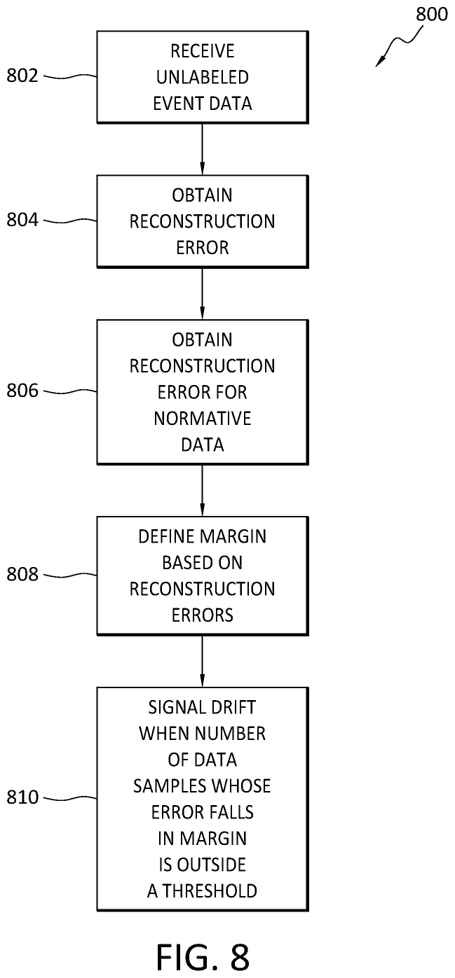

It is noted with respect to the disclosed methods, including the example method of FIG. 8, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 8, an example method 800 according to some embodiments is disclosed. The example method 800 may be performed in an unsupervised manner, that is, without the use of labeled data. Further, the example method 800 may be performed by a drift detection model, also operating in an unsupervised manner, and the drift detection model may be included as an element of an unsupervised event detection model that may be deployed to each node in a group of mobile edge nodes. Thus, the drift detection model may serve to evaluate the performance of the unsupervised event detection model.

With reference now to the particular example of FIG. 8, the method 800 may begin when a drift detection model receives 802 unlabeled data from and/or concerning performance of an unsupervised event detection model. Next, a reconstruction error for the unlabeled data may be determined 804, such as with the use of an auto-encoder for example. A reconstruction error may also be determined 806 for a group of normative data.

Using the reconstruction errors determined at 804 and 806, a margin may then be defined 808. The margin may define a range of reconstruction error values, and a size of the margin may be defined according to any suitable criteria. Thus, the margin may be referred to as a reference margin.

Finally, given a number of incoming data samples from the unsupervised event detection model to the drift detection model, a proportion of those data samples may have a reconstruction error that falls within the range of reconstruction errors defined by the margin. When that proportion is much larger, or much smaller, than a threshold value or range, drift in the performance of the unsupervised event detection model may be signaled 810.

When drift is signaled 810, for example, because the performance of the model is outside an acceptable range, various actions may be taken. For example, the unsupervised event detection model may be refined to improve its performance. Alternatively, the unsupervised event detection model may be replaced with a different model. Note that a certain amount of drift may be deemed to be acceptable, so long as, for example, the drift is within a defined range for example.

### F. Further Example Embodiments

Following are some further example embodiments of the invention. These are presented only by way of example and are not intended to limit the scope of the invention in any way.

Embodiment 1. A method, comprising: receiving a stream of unlabeled data samples from a model; obtaining a first reconstruction error for the unlabeled data samples; obtaining a second reconstruction error for a set of normative data; defining a margin based on the first reconstruction error and the second reconstruction error; computing an initial proportion of samples from the set of normative data whose reconstruction errors fall within a range of reconstruction errors defined by the margin; computing a new proportion of unlabeled data samples that fall within the range of reconstruction errors defined by the margin; and signaling drift in the performance of the model when said new proportion differs from said initial proportion by more than a predefined tolerance threshold.

Embodiment 2. The method as recited in embodiment 1, wherein the model is an unsupervised event detection model operable to detect events in a domain in which mobile edge devices are deployed.

Embodiment 3. The method as recited in any of embodiments 1-2, wherein when the drift is signaled, the model is retrained, and the margin and proportion are recomputed.

Embodiment 4. The method as recited in any of embodiments 1-3, wherein the stream of unlabeled data samples is generated by one or more mobile edge nodes.

Embodiment 5. The method as recited in any of embodiments 1-4, wherein prior to receiving the stream of unlabeled data samples, a model that performs the signaling of the drift is trained using a combination of anomalous data and the normative data.

Embodiment 6. The method as recited in any of embodiments 1-5, further comprising further comprising comparing a sequence of differences between the current proportions and the initial proportion to determine a drift in the performance of the model.

Embodiment 7. The method as recited in any of embodiments 1-6, wherein boundaries of the margin are defined by a plot of the second reconstruction error.

Embodiment 8. The method as recited in any of embodiments 1-7, wherein the model is deployed at each of a plurality of edge nodes.

Embodiment 9. The method as recited in any of embodiments 1-8, wherein the stream of unlabeled data samples comprises data about a movement and/or a position of a physical mobile edge device.

Embodiment 10. The method as recited in any of embodiments 1-9, wherein a size of the margin is variable based on constraints associated with an application domain where the model is deployed.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

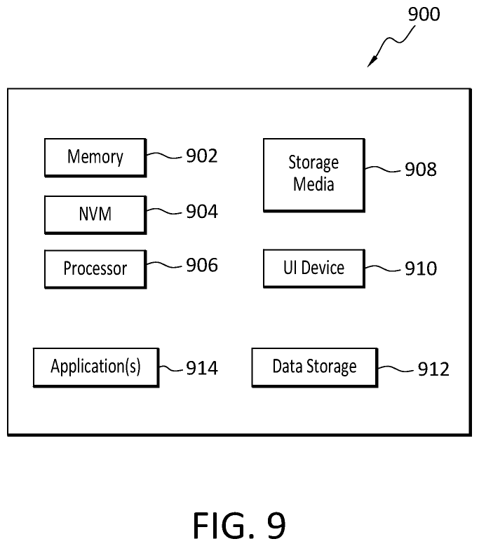

With reference briefly now to FIG. 9, any one or more of the entities disclosed, or implied, by FIGS. 1-8 and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI (user interface) device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a stream of unlabeled data samples from a model;
obtaining a first reconstruction error for the unlabeled data samples;
obtaining a second reconstruction error for a set of normative data;
defining a margin based on the first reconstruction error and the second reconstruction error;
computing an initial proportion of samples from the set of normative data whose reconstruction errors fall within a range of reconstruction errors defined by the margin;
computing a new proportion of unlabeled data samples that fall within the range of reconstruction errors defined by the margin; and
signaling drift in the performance of the model when said new proportion differs from said initial proportion by more than a predefined tolerance threshold.

2. The method as recited in claim 1, wherein the model is an unsupervised event detection model operable to detect events in a domain in which mobile edge devices are deployed.

3. The method as recited in claim 1, wherein when the drift is signaled, the model is retrained, and the margin and proportion are recomputed.

4. The method as recited in claim 1, wherein the stream of unlabeled data samples is generated by one or more mobile edge nodes.

5. The method as recited in claim 1, wherein prior to receiving the stream of unlabeled data samples, a model that performs the signaling of the drift is trained using a combination of anomalous data and the normative data.

6. The method as recited in claim 1, further comprising comparing a sequence of differences between the current proportions and the initial proportion to determine a drift in the performance of the model.

7. The method as recited in claim 1, wherein boundaries of the margin are defined by a plot of the second reconstruction error.

8. The method as recited in claim 1, wherein the model is deployed at each of a plurality of edge nodes.

9. The method as recited in claim 1, wherein the stream of unlabeled data samples comprises data about a movement and/or a position of a physical mobile edge device.

10. The method as recited in claim 1, wherein a size of the margin is variable based on constraints associated with an application domain where the model is deployed.

11. A non-transitory storage medium having stored therein instructions that are executable by one or more hardware processors to perform operations comprising:
receiving a stream of unlabeled data samples from a model;
obtaining a first reconstruction error for the unlabeled data samples;
obtaining a second reconstruction error for a set of normative data;
defining a margin based on the first reconstruction error and the second reconstruction error;
computing an initial proportion of samples from the set of normative data whose reconstruction errors fall within a range of reconstruction errors defined by the margin;
computing a new proportion of unlabeled data samples that fall within the range of reconstruction errors defined by the margin; and
signaling drift in the performance of the model when said new proportion differs from said initial proportion by more than a predefined tolerance threshold.

12. The non-transitory storage medium as recited in claim 11, wherein the model is an unsupervised event detection model operable to detect events in a domain in which mobile edge devices are deployed.

13. The non-transitory storage medium as recited in claim 11, wherein when the drift is signaled, the model is retrained, and the margin and proportion are recomputed.

14. The non-transitory storage medium as recited in claim 11, wherein the stream of unlabeled data samples is generated by one or more mobile edge nodes.

15. The non-transitory storage medium as recited in claim 11, wherein prior to receiving the stream of unlabeled data samples, a model that performs the signaling of the drift is trained using a combination of anomalous data and the normative data.

16. The non-transitory storage medium as recited in claim 11, wherein the operations further comprise comparing a sequence of differences between the current proportions and the initial proportion to determine a drift in the performance of the model.

17. The non-transitory storage medium as recited in claim 11, wherein boundaries of the margin are defined by a plot of the second reconstruction error.

18. The non-transitory storage medium as recited in claim 11, wherein the model is deployed at each of a plurality of edge nodes.

19. The non-transitory storage medium as recited in claim 11, wherein the stream of unlabeled data samples comprises data about a movement and/or a position of a physical mobile edge device.

20. The non-transitory storage medium as recited in claim 11, wherein a size of the margin is variable based on constraints associated with an application domain where the model is deployed.
